(19) United States
(12) Patent Application Publication
(10) Pub. No.: US 2026/0358831 A1
(43) Pub. Date: Nov. 12, 2026

(54) Autonomous Mining System

(71) Applicant: Fortescue Ltd., East Perth (AU)

(72) Inventors: Shane Wieske, East Perth (AU); Sam Moran, East Perth (AU)

(21) Appl. No.: 19/487,988

(22) PCT Filed: May 24, 2024
(86) PCT No.: PCT/AU2024/050542

§ 371 Date: Nov. 25, 2025

(30) Foreign Application Priority Data
May 26, 2023 (AU) 2023901654

(51) Int. Cl. G05D 1/69; G05D 107/70

(52) U.S. Cl. CPC G05D 1/69; G05D 2107/73

(57) ABSTRACT

An autonomous mining system for a mine site, comprising a plurality of vehicles, with each vehicle having a feature set associated therewith; and a central controller configured to send an instructing message to a selected one of said vehicles to perform a task on the mine site, with the message identifying capabilities required of the vehicle to complete the task; wherein each vehicle is configured to reject the task if the feature set of the respective vehicle does not match the capabilities required by the task.

### CROSS REFERENCE TO RELATED APPLICATIONS

This is a U.S. National Stage application, filed pursuant to 35 U.S.C. § 371, and claims the benefit of and priority to PCT Application Number 2024/050542, filed on May 24, 2024, and Australian Application Number 2023/901654, filed on May 26, 2023, each of which is incorporated by reference herein in its entirety.

### TECHNICAL FIELD

The present invention relates to a method of controlling a plurality of vehicles and/or associated machinery on a mine site. The present invention also relates to a system for controlling the plurality of autonomous vehicles and/or associated machinery on the mine site.

### BACKGROUND

Unmanned, autonomous and semi-autonomous vehicles are commonly used to perform a variety of tasks on a mining site. These vehicles are typically controlled by a central server, or by a controller on-board the vehicle. The tasks that a particular vehicle can perform are dependent on the vehicle's capabilities. In a system with more than one type of vehicle, each vehicle's capabilities may limit or otherwise hinder the type of tasks that it can carry out.

Existing systems for controlling vehicles in a mining environment do not provide a universal or otherwise easily expandable task interface. This means that task messages are strictly defined and inherently specific to particular types and/or makes of vehicle. Accordingly, it is typically difficult to add new vehicles to such systems. Further, adding a new capability or task type to the system often requires a new bespoke interface for each new task. Understandably, such processes are time consuming and reduce the efficiency of the system.

A drawback of existing autonomous vehicle control systems is an inability for tasks to be executed in parallel. That is, each task can only be executed independently without taking into account any cross-dependency on another task. As a result, the efficiency of such vehicles is limited, as it is generally necessary for tasks to be completed sequentially or at the very least broken down into a series of discrete, incremental steps.

The applicant has determined that it would be advantageous to provide an improved system and method of controlling a plurality of autonomous or semi-autonomous vehicles, which allow new vehicles with new functionality to be added to the system easily.

The present invention, in its preferred embodiments, seeks to at least in part alleviate the above-identified problems or to provide the public with a useful choice.

### SUMMARY

According to an aspect of the present invention, there is provided an autonomous mining system for a mine site, comprising a plurality of vehicles, with each vehicle having a feature set associated therewith; and a central controller configured to send an instructing message to a selected one of said vehicles to perform a task on the mine site, with the message identifying capabilities required of the vehicle to complete the task; wherein each of the vehicles is configured to reject the task if the feature set of the respective vehicle does not match the capabilities required by the task.

According to another aspect of the present invention, there is provided an autonomous mining system for a mine site comprising a plurality of vehicles, with each vehicle having a feature set associated therewith; and a central controller configured to send an instructing message to a selected one of said vehicles to perform a task on the mine site, with the message identifying capabilities required of the vehicle to complete the task; wherein each of the vehicles is configured to accept the task if the feature set of the respective vehicle matches the capabilities required by the task.

In some embodiments, each vehicle may have a local controller that is configured to receive and interrogate the message sent by the central controller. In use, the local controller of each vehicle can compare the capabilities identified within the message with the feature set of said vehicle as stored within the local controller. The local controller of each vehicle can be configured to send a response to the central controller after the message has been interrogated. The response from the local controller indicates whether the task has been accepted by the respective vehicle.

In some embodiments, the capabilities are listed in a discrete verification block within the message. In other embodiments, the capabilities are implicitly defined across a body of the message. The capabilities can be selected from a library of capabilities stored within the central controller, the library comprising records of the respective feature sets of the plurality of vehicles.

In some embodiments, the plurality of vehicles includes a first vehicle type having a first feature set and a second vehicle type having a second feature set, wherein, in use, a task that is rejected by a vehicle of the first vehicle type is accepted by a vehicle of the second vehicle type if the feature set of the second vehicle matches the capabilities required by the task.

In some embodiments, the local controller of each vehicle may comprise a receiver. The receiver can receive all task communications from the central controller. The receiver may have a memory configured to store new tasks received from the central controller until they are ready to be performed.

In some embodiments, each vehicle comprises at least one execution module in communication with the local controller thereof. Each of the at least one execution modules may execute tasks that are allocated by the receiver. Each of the at least one execution modules may execute one task at a time.

In some embodiments, the local controller of each vehicle has a memory for storing tasks, with an order of tasks and their dependencies being arranged in a chart wherein each execution module has a unique path through the chart.

According to another aspect of the present invention, there is provided an autonomous vehicle for use with the mining system as outlined above.

According to another aspect of the present invention, there is provided a method of operating a plurality of vehicles on a mine site comprising the steps of sending, by a central controller, a message to a selected one of the plurality of vehicles instructing said vehicle to perform a task, the message identifying capabilities required of the vehicle to complete the task; interrogating, by a respective vehicle, the message from the central controller to determine if a feature set associated with said vehicle matches the capabilities identified in the message; and rejecting, by a respective vehicle, the task if the feature set of said vehicle does not match the capabilities required by the task.

According to another aspect of the present invention, the step of rejecting the task may be replaced by accepting, by a respective vehicle, the task if the feature set of said vehicle matches the capabilities required by the task.

According to another aspect of the present invention, there is provided an autonomous mining system for a mine site, comprising a plurality of machines, with each machine having a feature set associated therewith; and a central controller configured to send an instructing message to a selected one of said machines to perform a task on the mine site, with the message identifying capabilities required of the machines to complete the task; wherein each machine is configured to reject the task if the feature set of the respective machine does not match the capabilities required by the task.

According to another aspect of the present invention, there is provided an autonomous mining system for a mine site, comprising a plurality of machines and a central controller configured to send an instructing message to a selected one of said machines to perform a task on the mine site, each machine having a local controller for storing tasks in a queue, tasks within the queue being executed by the local controller in an order, wherein the order is dictated by a plurality of rules.

Each machine may include a plurality of execution modules for executing tasks that are allocated by the local controller, wherein the plurality of rules includes at least one rule that is selected from the following group of rules:
each task can be executed by only one execution module;
there are to be no circular dependencies;
there are to be no parallel tasks within a particular execution module;
each execution module can handle one root task only;
there is only one path through a given set of tasks for each execution module; and
there can be no blocking deadlocks.

In some embodiments, the local controller is programmable to ensure that the plurality of rules must be followed even if additional tasks are added to the queue or withdrawn from the queue. An order of tasks and their dependencies may be arranged in a chart, the chart capturing information on which tasks must execute sequentially or in parallel, with staccato execution or with smoothly blended execution of subsequent tasks, or any combination thereof.

According to another aspect of the present invention, there is provided an autonomous mining system comprising a plurality of different machines that perform tasks on a mine site and a central controller that instructs the machines to perform particular tasks, wherein instructing messages sent by the central controller to the machines use a universal format that is independent of machine and task type.

According to another aspect of the present invention, there is provided an autonomous mining system comprising a plurality of machines that perform respective tasks on a mine site and a central controller that sends instructions to the machines to perform a particular task, wherein a tasks to be carried out by a respective machine are scheduled via a chart stored in a memory of that machine.

According to another aspect of the invention, there is provided a method of mining, including the steps of: instructing machines on a mine site to perform particular tasks; performing a series of tasks with each machine; and transitioning between tasks with each machine in an order and manner that is scheduled via a chart stored in a memory of that machine.

### BRIEF DESCRIPTION OF THE DRAWINGS

A particular embodiment of the invention will now be described, by way of non-limiting example only and with reference to the accompanying drawings, in which:

FIG. 1 shows an autonomous system for controlling vehicles on a mine site.

FIG. 2 is a logic diagram showing functional components of the system of FIG. 1.

FIG. 3 shows a first embodiment of a message that forms part of the logic diagram shown in FIG. 2.

FIG. 4 shows a local controller of a vehicle of the system of FIG. 1.

FIG. 5 shows a task dependency chart that forms part of the logic diagram shown in FIG. 2.

FIG. 6 is a schematic drawing showing steps of an embodiment of a method of operating a plurality of vehicles on a mine site.

### DETAILED DESCRIPTION

In broad terms, the invention is directed towards a mining system 10 for a mine site. The system comprises a plurality of vehicles 102, with each vehicle 102 having a feature set 118 associated therewith, and a central controller 210 that is configured to send a message 212 instructing a selected one of the vehicles to perform a task 216, or tasks, on the mine site. The message identifies capabilities required of the vehicle for satisfactory completion of the task 216. In use, a task 216 is rejected by a vehicle if the feature set 118 of the respective vehicle 102 does not match the capabilities required by the task 216, whilst the task 216 is accepted if the feature set 118 of the vehicle 102 matches the capabilities of the task 216.

Throughout much of the description below, the mining system 10 will be described as an autonomous mining system, with the vehicles 102 being autonomous vehicles. It is understood, however, that the invention is not limited to such a preferred embodiment, and can also be applied to semi-autonomous vehicles or indeed, to vehicles that are substantially controlled by an on-board operator. Furthermore, it is understood that the mining system 10 is suitable for use with other associated machinery operating on a mining site. Such machinery may include, for example, reclaimers, stackers, conveyors, robots, multi-axis arms and bespoke end effectors and/or tools.

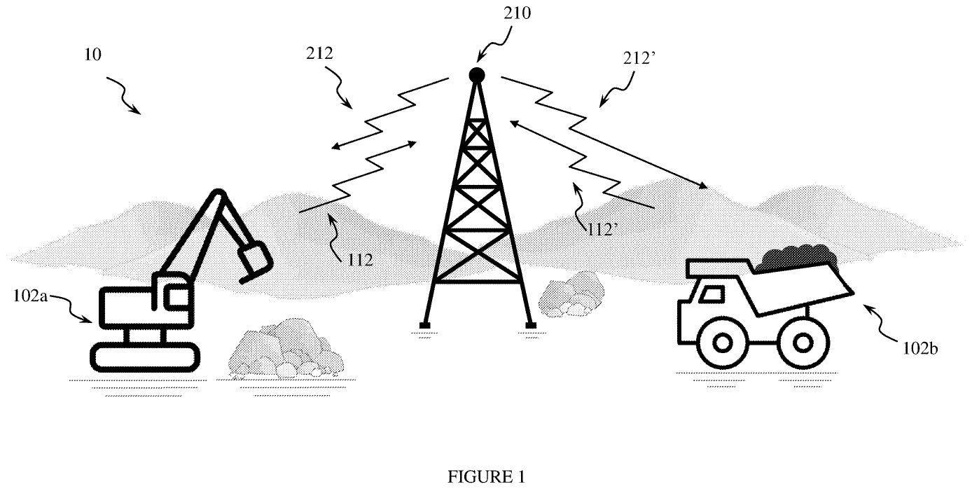

The mining system 10 will now be described in detail with reference to FIGS. 1 to 6.

FIG. 1 illustrates a preferred embodiment of the invention, with a central controller 210 being arranged to wirelessly send a message 212 to a selected one of a plurality of mining vehicles 102 operating within a mining site. As shown, the vehicles 102 include a first mining vehicle 102a in the form of a digger and a second mining vehicle 102b in the form of a hauler or dump truck. The central controller 210 is in two way communication with the vehicles 102. What is meant by this is that the mining system 10 includes a feedback system, such that the status of each vehicle 102 is known by the controller 210, via response telegrams 112. This feedback assists in the operation of the system 10, in that the controller 210 uses the status of a respective vehicle 102 when selecting or which vehicle 102 a message 212 should be addressed to. In this way, the operation of the mining site can be optimized, with idle and/or transit time (together representing ‘non-working’ time) of respective vehicles 102 minimised. Notably, the structure of messages 216, 216′ is independent of the type of vehicle 102 operating on the mining site—put differently, messages 216 have a ‘universal type’ format, resulting in a ‘modular’ or otherwise expandable system 10. This expandability of system 10 simplifies the way in which new vehicles and vehicle types 102 are added into the system 10—substantially eliminating the need to develop a bespoke interface for each vehicle. The universal message format provides a single interface to represent all types of vehicle 102 and tasks 216 and is easily expandable. In other words, the system uses a single message structure irrespective of vehicle and task type such that the effort required to introduce new instruction types based on said new vehicles and/or new task types is also reduced for the reasons outlined above.

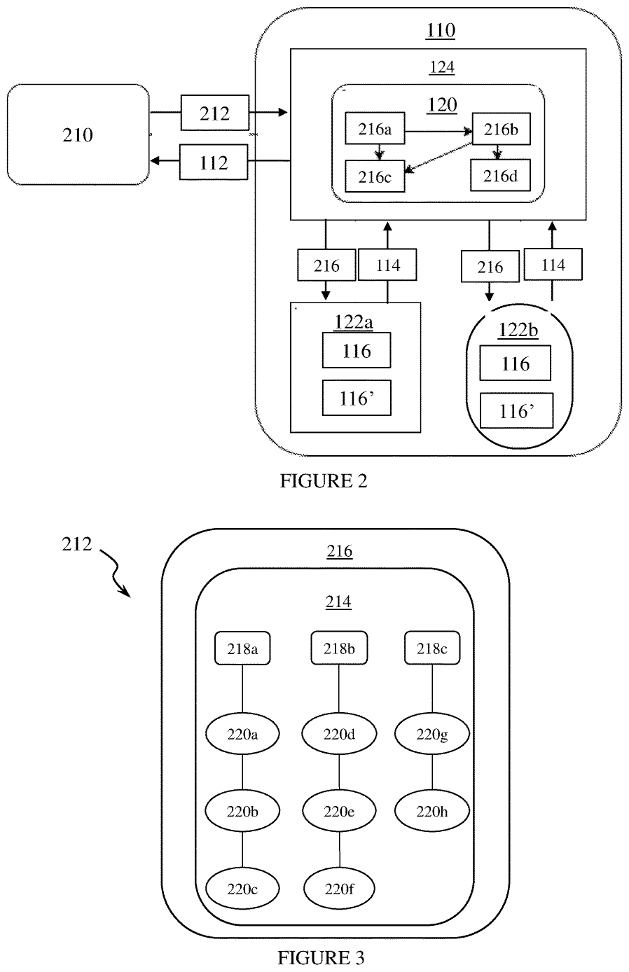

The operation logic of the system of FIG. 1 is represented schematically in FIG. 2.

As shown in FIG. 2, a task 216 represents a discrete block of instructions to be done by a vehicle 102. The tasks 216 are sent from the central controller 210 to an on-board control system 110 of a vehicle 102. The on-board control system or local controller 110 comprises two main components: a receiver 124 and an execution module 122, each of which is carried by the vehicle 102.

The receiver 124 receives task communication from the central controller 210. New tasks 216 from the central controller 210 are received by the receiver 124 which then allocates the respective task 216 to an execution module 122. The receiver 124 includes a memory or buffer 120, such that incoming tasks 216 from the central controller 210 are stored within the receiver 124 before being allocated to the appropriate execution module 122. With particular reference to the example shown in FIG. 2, four tasks 216a, 216b, 216c and 216d are stored within the memory 120 of the receiver 124.

Execution modules 122 are configured to perform the tasks 216 that are allocated to said modules 122 by the receiver 124. Each vehicle 102 may include one or more execution modules 122. Each execution module 122 performs one task 216 at a time. With reference to the embodiment shown in FIG. 2, the vehicle 102 includes two execution modules 122a and 122b, with each module 122 having two execution or job slots 116—the “active job slot” 116 and the “next job slot” 116′.

Referring now to FIG. 3, the message 212 has a structure that follows a communication protocol and application programming interface standard. The message 212 is used to communicate between nodes of the local controller 110, and between the local controller 110 and the central controller 210. It is contemplated that the message 212 is defined in an interface definition language (IDL) that defines data structures and interfaces used for the communication protocol. The IDL of the message 212 is independent of operating system and programming language.

The message 212 structure is configured to capture all input parameters required to execute a desired task 216. Each message 212 identifies at least one vehicle capability 218, required by the task 216. The capabilities 218 may be listed in a discrete data or “verification” block at a header of the message 212. Preferably, however, the capabilities 218 required of the vehicle 102 are prescribed within fields of a body 214 of the message 212 itself. Examples of capabilities 218 required for vehicles 102 within a mining application may include ‘Move’, ‘Dump’ and ‘Mode Change’. The capabilities 218 may also prescribe a desired speed that the vehicle is required to move at, and/or prescribe the type of terrain that the vehicle must be able to travel over. The capabilities 218 are communicated by the central controller 210 using data objects. For example, the data objects may take the form of sequences and or strings within the message body 214. In the Figure, three capabilities are schematically illustrated and labelled 218a, 218b and 218c respectively.

The capabilities 218 identified within the message 212 are selected from a library or database comprising a record of the supported feature sets of all vehicles in the mine site is stored within the central controller 210. Each required capability 218 comprises a set of one of more actions 114. Actions 114 are at the lowest level of the message 212 and represent specific instructions to the vehicle 102. In the Figure, capability 218a has three actions 220a-c associated therewith, capability 218b has three actions 220d-f associated therewith, whilst capability 218c has two actions 220g-h associated therewith.

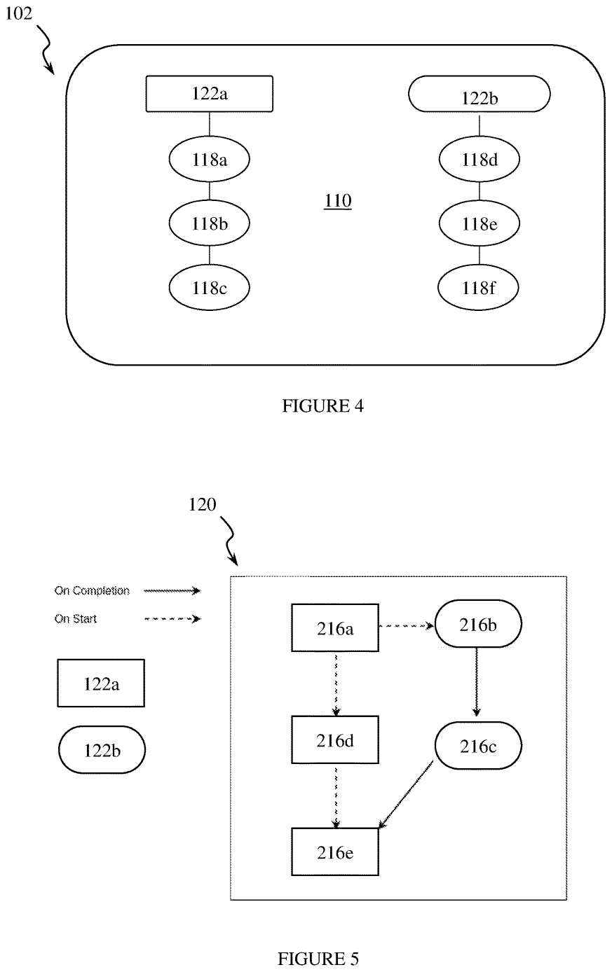

Moving now to FIG. 4. The capabilities 218 that a vehicle 102 supports, and thus tasks 216 that a vehicle 102 is capable of performing is determined by the arrangement and configuration of the vehicle itself. Different types of vehicles 102, for example those of digger 102a and dump truck 102b, are capable of fulfilling tasks 216 requiring different capabilities 218.

Each execution module 122 has at least one set of features 118 associated therewith that are used to execute a respective task 116. The features 118 of the vehicle correspond with the actions 114 of each capability 218. With particular reference to the embodiment shown in the Figure, the vehicle 102 includes two execution modules 122a and 122b. Execution module 122a has a feature set that includes three features 118a-c whilst execution module 122b also has a feature set with three features, namely 118d-118f. A list of supported feature combinations is provided by the vehicle to the central controller 210 during initialization of the vehicle, and used to build the database of supported capabilities 218.

When receiving a message 212, the receiver 124 determines which capabilities 218 are associated with each execution module 122. The receiver 124 matches the data between incoming task messages 212 from the central controller 210 and the execution module 122 data types, and assigns the task 216 to the appropriate execution module 122. Tasks 216 are matched to execution modules 122 through feature combinations. Each execution module 122 supports a set of unique feature combinations, and no two execution modules 122 on the same vehicle can support the same feature combination. If a message 212 contains action combinations that do not meet any of the execution module 122 feature combinations, then that message 212 is rejected by the receiver 124.

Turning now to FIG. 5. Task dependencies are used to control the order in which tasks are executed by the execution modules 122.

The order of which tasks 216 are processed by the receiver 124 are dictated by a plurality of rules. The rules are set within the receiver 124. The rules followed by the receiver 124 when ordering tasks 216 can include:
each task can be executed by only one execution module 122;
there are to be no circular dependencies;
there are to be no parallel tasks within a particular execution module 122;
each execution module 122 can handle one root task only;
there is only one path through a given set of tasks for each execution module 122; and
there can be no blocking deadlocks.

The receiver is programmable to ensure that a selected number of these rules must be followed even if additional tasks 216 are added to the queue, or tasks 216 are withdrawn from the queue. The dependency chain for each task needs to be kept intact through the task queue. Tasks can only be removed from the queue if their completion status is no longer needed in the dependency chain.

A list of queued tasks within the memory 120 of the receiver 124 may not necessarily be a sequential list of execution, but rather the memory 120 may take the form of a chart 120 of tasks and dependencies where each execution module 122 has a unique path through the chart 120, effectively setting a schedule via which the tasks 216 are executed. The chart 120 shown in the Figure is a “directed graph”. Each task has at least one blocking dependency relationship with another task unless it is the only task in the queue associated with a particular execution module 122. A dependency can be used to prevent the execution of the blocked task until a certain condition is met. This condition can be either that the blocked task remains blocked until the blocking task begins executing, or the blocked task remain blocked until the blocking task has completed execution. Completion of execution can be either due to a successful task completion or cancellation of the task.

The above framework allows for task management of vehicles on a mine site, including the following examples. Instructing a truck and digger at the same time with the same interface; seamless execution of sequential tasks (e.g. instructing a digger to move from one point to another, then move again to yet another point); and parallel execution of compatible tasks (e.g. instructing a truck to move while dumping). For example, trials successfully carried out by the applicant include instructing a haul truck to move around a mine site, and instructing a road train truck to perform moving and dumping tasks.

The task chart 120 allows each vehicle to track or otherwise schedule its tasks and execute them efficiently. It enables and communicates task order of execution, task blending for smooth transitions between tasks, and parallel task execution for complex robot behaviors. The task chart links tasks to other tasks based on the dependencies of each task. Conditions on the dependencies control blending and parallel tasks when combined with execution modules 122. While some tasks can be done in parallel (e.g. moving and taking pictures), other tasks cannot be done in parallel (e.g. driving to two locations at once). When a task 216 is executed by a vehicle 102, it is the execution module 122 that matches the feature combination from the message 212 that will be used. Summarily, it is understood that a strength of the task chart 120 is that it provides a particularly robust way to smoothly transition from one task to another, and/or to execute tasks in parallel.

Each message 212 sent from the central controller 210 to a respective local controller 110 may include the following commands within the message body 214. An “insert” command can be used to insert a task in to the task queue. This command uses the dependencies provided in the message 212 to determine where the task sits in the task chart 120. Tasks may be inserted into the middle of the chart 120 or appended to the end of an execution module task path. A “replace” command can be used to replace a task that is already in the task queue. A flag in the replace command can be used to determine whether the dependencies associated with the replaced task should be transferred to the new task. The dependencies provided in the new task are also used even if the old task dependencies are transferred. A “remove” command may be used to remove one or more tasks from the task queue. A “clear” command can be used to clear the queue of all tasks.

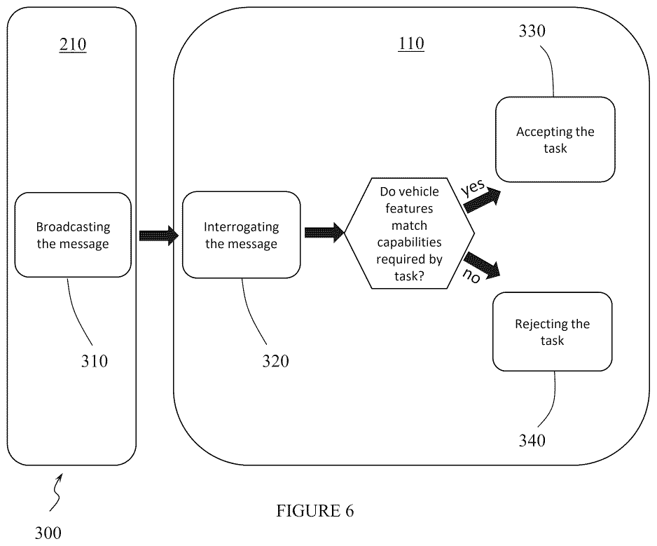

The task chart 120 shown in FIG. 6 provides an example of the task chart's ability to provide the central controller 210 with detailed information about a vehicle's behavior and/or status. Put differently, the chart 120 captures information on which tasks must execute sequentially or in parallel, with staccato execution or with smoothly blended legato execution of subsequent tasks, or any combination thereof. With particular reference to the illustrated embodiment, a vehicle would behave in the following way. Task 216b would start immediately after task 216a and execute in parallel, as both tasks 216a, 216b are connected with an “on start” dependency and are served by different execution modules 122a,b. Task 216a would smoothly transition to a further task 216d, with tasks 216a and 216d also being connected with an “on start” dependency and served by the same execution module 122a. Task 216c will only start on completion of task 216b, as tasks 216b and 216c are linked with an “on completion” dependency. In turn, task 216d will smoothly transition into task 216e once 216c has completed. If task 216d finishes before task 216c, task 216e will be held until the completion of task 216c and no smooth transition will occur.

If the task chart 120 is modified by a new message 212, the task dependencies can be updated. For example, if a respective task is cancelled, its dependencies are inherited by the downstream tasks. This means that if a task has a dependency on a cancelled task, it will inherit the cancelled task's dependencies. After the task chart 120 has been modified, it will be checked for redundant dependencies. Any redundant dependencies will be removed from the task chart 120. After the task chart 120 has been checked for redundancies, the task chart 120 will be checked for errors that would result in an invalid task chart 120. Examples of errors that would result in an invalid task chart 120 include circular task dependencies, parallel tasks on one execution module 122, and more than one execution path through the chart for a particular execution module 122.

Communication from the receiver 124 to a respective execution module 122 of the vehicle 102 may include the following commands. The “Load” command can be used to load a new task. This can also be used to overwrite any tasks that is queued to be executed next. The “cancel” command can be used to cancel one or more tasks based on the unique identification of each task. This command can be used to cancel the active task, the task to be executed next, or both.

The receiver 124 can decide when to send a task to be loaded in an execution module 122 based on the blocking status of the task. Task blocking is not considered by the execution module 122, because the execution modules 122 themselves do not require or necessarily have knowledge of task dependencies. Rather, each execution module 122 may only require information about up to two tasks, stored within job slots 116: the “active job” 116′ and the “next job” 116″. The active job slot 116 contains the task that is currently executing, and the next job slot 116′ contains is the next task to be executed. If a task is loaded into next job slot, it is assumed the task within the active job 116 is allowed to transition to the task within next job slot 116′. Each execution module 122 can execute one task at a time, but vehicles 102 can comprise one or more execution modules 122. The execution modules 122 can then work in parallel to achieve simultaneous task execution.

Tasks 216 from the receiver 124 are only loaded into the next job slot 116′ on the execution module 122. Whether a task is loaded successfully into next job task 116′ is not dependent on the contents of next job slot 116′ or active job slot 116. The task within the active job slot 116 is only replaced by the task within the next job slot 116′ if the task can be merged and the task within the active job slot 116 is executing, or if the task within the active job slot 116 status is complete. If the execution module 122 supports merging from the active job slot 116 to the next job slot 116′, the tasks therein will be merged as soon as possible. The task within the next job slot 116′ can be loaded into the active job slot 116 if the active job 116 is empty.

Returning now to FIG. 2. The status of each task is reported from the execution module 122 to the receiver 124 via feedback 114, and then from the receiver 124 to central controller 210 in response telegram 112. The structure of the response telegram 112 is similar to the message 212. The feedback 114 that is returned within the response telegram 112 includes status values for active tasks and may include metadata for the next task. The response telegram 112 passed from the receiver 124 to the central controller 210 contains a sequence of statuses of all the tasks that the receiver 124 knows about and includes the current dependency chart 120.

The system 10 is expandable. What is meant by this is that the system architecture is designed to make it simple to include vehicles with new functionality. This expandability is much preferred over existing systems, where OEM vehicles have associated bespoke communication interfaces for each task type required. If bespoke interfaces were required, each time a new task is defined, the following steps would need to be taken. The system would have to be adapted to support the new functionality and be updated to support the new bespoke interface. The link between the central controller 210 and the local controller 110 would need to be modified to support the new interface. Each new task would require the parameters of the task to be defined in a bespoke script. Finally, the receiver on-board the vehicle would need to be updated to be able to read from the new interface, and the execution module would need to be created or adapted to handle the new task. It is understood that, in some situations, minor reworking of OEM software may be required for successful integration of the system 10.

In the case of the autonomous system for a mine site 10, each time a new task is defined, the following steps are taken. The system 10 is adapted to support the new functionality. The message 212 is expanded to add the additional parameters for the new task. Finally, execution modules 122 are created or adapted to handle the new task.

As above, the autonomous system for a mine site 10 requires less re-writing of the system infrastructure to accommodate new tasks. Repetition of code elements is avoided because tasks do not need to be duplicated just to add a new attribute 218 and/or action 220. The receiver 124 does not need any software changes due to dynamic task definition discovery of the execution modules 122 by the receiver 124.

For example, if a new type of vehicle such as a water truck designed for spraying dirt or gravel roads with water to suppress dust is added to the system, a new capability 218 is added to the message 212. In this case, the new capability 218 would include a set of actions 220 associated with the water spraying function. A task 216 addressed to this action would also include a list of path segments defining where the truck must spray. These segments might be different to the path followed by the truck since only some section of the road might need to be sprayed. In this embodiment, the message 212 would be modified to add the water spraying capability to the task-thus ensuring said task is only accepted by a vehicle having the necessary feature set 118 to perform the action. The remainder of the message 212 would otherwise be substantially identical to the message for other types of vehicles that travel along the same road.

A method 300 of operating a plurality of vehicles on mine site will now be described with reference to FIG. 6. It is to be understood that even though the autonomous system 10 has been purpose-designed for a mine site, the autonomous system may also be suitable for use in unrelated applications.

In an initial step 310 of operating a plurality of vehicles on a mine site, a message 212 is sent from a central controller to a selected vehicle 102. The message 212 includes instructions for said vehicle 102 to perform a task 216. Capabilities 218 required of the vehicle 102 in order to perform the task 216 are identified within a body 214 of the message 212. During this step 310, it is understood that the central controller 210 may select a vehicle 102 in accordance with various attributes including the required capabilities 218 for a task 216, the status of a vehicle 102 (i.e. active or static), and the location or proximity of a vehicle 102 to a destination or working area of the task 216 on the worksite. In an alternate embodiment, it is understood that the message 212 may be broadcast to a plurality of vehicles 102, with the respective local controllers 110 thereof processing the message 212 before electing to accept or reject the task 216.

In a subsequent step 320, the targeted vehicle 102 interrogates the message 212 to determine if its feature set 118 matches the capabilities 218 identified in the message 212—and more specifically the actions 220 associated with identified capability 218. For example, if the capabilities identified in the message include “spray” and “refill”, the message 212 is directed to a truck that is able to spray water on a road. Alternatively, if the capabilities 218 and identified include “dig”, “turn” and “release”, it the message is directed to a digger.

A truck suitable for spraying would not include these features for “dig” “turn” and “release” in its feature set. Likewise, “spray” and “refill” would not be included in the digger's feature set. If the feature set 118 of a vehicle does not match the capabilities 218 required of the vehicle 102 by the task 216, the vehicle will reject the message 212 in a rejecting step 340.

Alternatively, if the feature set of a vehicle does match the capabilities and features required by the task, the vehicle will accept the message 212 in an accepting step 330. That is, if the capabilities 218 included in the message matches the features 118 of the vehicle, the message will be accepted by the vehicle 102.

Summarily, it is understood that the mining system described herein provides an improved mining method may result in an improved, cost effective substantially autonomous mining operation. This is achieved, at least in part, due to the provision of a central controller that is configured to send an instructing message to a selected one of a plurality of vehicles, with each of said vehicles having a unique feature set associated therewith. Each of the vehicles has an onboard local controller that is configured to reject the message if the vehicle is not capable of performing the task instructed by the message. This “two-way” feedback between the central controller and the vehicles means that the structure of the message is substantially universal, or independent of vehicle type and capability. In this way, the resources and effort associated with operating an autonomous mining site are reduced-which, in particular, provides for improved expandability of the system by simplifying the steps required to add further vehicles and capabilities into the system. Additionally, whereas existing systems typically use separate message formats for each different task type, the mining system described herein uses a single, unified message format to represent all task and vehicle types and is therefore easily expandable.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavor to which this specification relates.

Throughout this specification and the claims which follow, unless the context requires otherwise, the word ‘comprise’, and variations such as ‘comprises’ and ‘comprising’, will be understood to imply the inclusion of a stated integer or step or group of integers or steps but not the exclusion of any other integer or step or group of integers or steps.

LEGEND

| | |
|---|---|
| 10 | Mining system |
| 102 | Vehicle |
| 110 | Local Controller |
| 112 | Response |
| 114 | Feedback |
| 116 | Active Job Slot |
| 116′ | Next Job Slot |
| 118 | Features |
| 120 | Task Chart |
| 122 | Execution Module |
| 124 | Receiver Module |
| 210 | Central controller |
| 212 | Message |
| 214 | Message Body |
| 216 | Task |
| 218 | Capabilities |
| 220 | Actions |
| 300 | Method |
| 310 | Broadcasting step |
| 320 | Interrogating step |
| 330 | Accepting step |
| 340 | Rejecting step |

1. An autonomous mining system for a mine site, comprising a plurality of vehicles, with each vehicle having a feature set associated therewith; and a central controller configured to send an instructing message to a selected one of said vehicles to perform a task on the mine site, with the message identifying capabilities required of the vehicle to complete the task; wherein each vehicle is configured to reject the task if the feature set of the respective vehicle does not match the capabilities required by the task.

2. An autonomous mining system for a mine site, comprising a plurality of vehicles, with each vehicle having a feature set associated therewith; and a central controller configured to send an instructing message to a selected one of said vehicles to perform a task on the mine site, with the message identifying capabilities required of the vehicle to complete the task; wherein each vehicle is configured to accept the task if the feature set of the respective vehicle matches the capabilities required by the task.

3. The autonomous mining system of claim 1 or claim 2, wherein each vehicle has a local controller that is configured to receive and interrogate the message sent by the central controller.

4. The autonomous mining system of claim 3, wherein, in use, the local controller of each vehicle compares the capabilities identified within the message with the feature set of said vehicle as stored within the local controller.

5. The autonomous mining system of claim 3 or claim 4, wherein the local controller of each vehicle is configured to send a response to the central controller after the message has been interrogated.

6. The autonomous mining system of claim 5, wherein the response from the local controller indicates whether the task has been accepted by the respective vehicle.

7. The autonomous mining system of any one of the preceding claims, wherein the capabilities are listed in a discrete verification block within the message.

8. The autonomous mining system of any one of claims 1 to 6, wherein the capabilities are implicitly defined across a body of the message.

9. The autonomous mining system of any one of the preceding claims, wherein the capabilities are selected from a library of capabilities stored within the central controller, the library comprising records of the respective feature sets of the plurality of vehicles.

10. The autonomous mining system of any one of the preceding claims, wherein the plurality of vehicles includes a first vehicle type having a first feature set and a second vehicle type having a second feature set, wherein, in use, a task that is rejected by a vehicle of the first vehicle type is accepted by a vehicle of the second vehicle type if the feature set of the second vehicle matches the capabilities required by the task.

11. The autonomous mining system of any one of the preceding claims, wherein the local controller of each vehicle comprises a receiver.

12. The autonomous mining system of claim 11, wherein the receiver receives all task communications from the central controller.

13. The autonomous mining system of claim 11 or claim 12, wherein the receiver has a memory configured to store new tasks received from the central controller until they are ready to be performed.

14. The autonomous mining system of any one of the preceding claims, wherein each vehicle comprises at least one execution module in communication with the local controller thereof.

15. The autonomous mining system of any one of claims 11 to 14, wherein each of the at least one execution modules executes tasks that are allocated by the receiver.

16. The autonomous mining system of any one of claims 11 to 15, wherein each of the at least one execution modules executes one task at a time.

17. The autonomous mining system of any one of claims 14 to 16, wherein the local controller of each vehicle has a memory for storing tasks, with an order of tasks and their dependencies being arranged in a chart wherein each execution module has a unique path through the chart.

18. An autonomous vehicle for use with the mining system of any one of the preceding claims.

19. A method of operating a plurality of vehicles on a mine site, comprising the steps of:
sending, by a central controller, a message to a selected one of the plurality of vehicles instructing said vehicle to perform a task, the message identifying capabilities required of the vehicle to complete the task;
interrogating, by a respective vehicle, the message from the central controller to determine if a feature set associated with said vehicle matches the capabilities identified in the message; and
rejecting, by a respective vehicle, the task if the feature set of said vehicle does not match the capabilities required by the task.

20. A method of operating a plurality of vehicles on a mine site, comprising the steps of:
sending, by a central controller, a message to a selected one of the plurality of vehicles instructing said vehicle to perform a task, the message identifying capabilities required of the vehicle to complete the task;
interrogating, by a respective vehicle, the message from the central controller to determine if a feature set associated with said vehicle matches the capabilities identified in the message; and
accepting, by a respective vehicle, the task if the feature set of said vehicle matches the capabilities required by the task.

21. An autonomous mining system for a mine site, comprising a plurality of machines, with each machine having a feature set associated therewith; and a central controller configured to send an instructing message to a selected one of said machines to perform a task on the mine site, with the message identifying capabilities required of the machines to complete the task; wherein each machine is configured to reject the task if the feature set of the respective machine does not match the capabilities required by the task.

22. An autonomous mining system for a mine site, comprising a plurality of machines and a central controller configured to send an instructing message to a selected one of said machines to perform a task on the mine site, each machine having a local controller for storing tasks in a queue, tasks within the queue being executed by the local controller in an order, wherein the order is dictated by a plurality of rules.

23. The autonomous mining system of claim 22, with each machine including a plurality of execution modules for executing tasks that are allocated by the local controller, wherein the plurality of rules includes at least one rule that is selected from the following group of rules:
each task can be executed by only one execution module;
there are to be no circular dependencies;
there are to be no parallel tasks within a particular execution module;
each execution module can handle one root task only;
there is only one path through a given set of tasks for each execution module; and
there can be no blocking deadlocks.

24. The autonomous mining system of claim 22 or claim 23, wherein the local controller is programmable to ensure that the plurality of rules must be followed even if additional tasks are added to the queue or withdrawn from the queue.

25. The autonomous mining system of any one of claims 22 to 24, wherein an order of tasks and their dependencies is arranged in a chart, the chart capturing information on which tasks must execute sequentially or in parallel, with staccato execution or with smoothly blended execution of subsequent tasks, or any combination thereof.

26. An autonomous mining system comprising a plurality of different machines that perform tasks on a mine site and a central controller that instructs the machines to perform particular tasks, wherein instructing messages sent by the central controller to the machines use a universal format that is independent of machine and task type.

27. An autonomous mining system comprising a plurality of machines that perform tasks on a mine site and a central controller that instructs the machines to perform particular tasks, wherein tasks to be carried out by a respective machine are scheduled via a chart stored in a memory of that machine.

28. A method of mining, including the steps of:
instructing machines on a mine site to perform particular tasks;
performing a series of tasks with each machine; and
transitioning between tasks with each machine in an order and manner that is scheduled via a chart stored in a memory of that machine.
